(19) United States
(12) Patent Application Publication
(10) Pub. No.: US 2017/0130888 A1
(43) Pub. Date: May 11, 2017

(54) FLEXIBLE AND MODULAR, SELF-SINKING SUBMARINE HOSES AND THEIR METHODS OF MANUFACTURE AND USE

(71) Applicant: Thunder Technologies LLC, Rochester Hill, MI (US)

(72) Inventors: Marc Kalinowski, Troy, MI (US); Michael Morgan, Rochester, MI (US); James W. Taylor, II, Royal Oak, MI (US)

(73) Assignee: Thunder Technologies LLC, Rochester Hill, MI (US)

(21) Appl. No.: 15/246,605

(22) Filed: Aug. 25, 2016

Related U.S. Application Data
(60) Provisional application No. 62/212,663, filed on Sep. 1, 2015.

(51) Int. Cl. F16L 55/00; F16L 11/15; F16L 11/02

(52) U.S. Cl. CPC F16L 55/00; F16L 11/02; F16L 11/15

(57) ABSTRACT

A stainless steel 316 hose with buoyancy counterweights is demonstrated that is heavy enough to sink even when full of air that would normally have sunk without having to use concrete mats or other anchoring means. The buoyancy counterweights can be steel pipe segments that the hose is run through and welded to or spurious flanges that are welded to the hose at discrete increments.

### RELATED APPLICATIONS

The present application claims the benefit under 35 U.S.C. 199(e) of U.S. Provisional Patent Application No. 62/212,663, filed on Sep. 1, 2015 which is hereby incorporated by reference in its entirety.

### BACKGROUND OF THE INVENTION

Off shore or marine equipment—such as inter alia military ships, civilian boats, other vessels, and oil platforms—will generally need a fluid connection to various fluid reservoirs for various purposes. For example, ships, boats, and other marine vessels may require fuel and fresh water supply lines and waste disposal lines. Oil platforms may require means to transport crude oil back to a storage facility or refinery back on the mainland.

According to Archimedes' principle, the positive buoyant force that is exerted in a body immersed in a fluid is equal to the weight of the fluid that the body displaces. Therefore, given the density of sea water or possibly water, the weight of the fluid displaced by a hose can be significant, giving rise to two major types of marine transport hoses: floating and submarine hoses.

Floating hoses, as one would expect, float on the water when they are empty due to having a lower density overall than the water itself; in terms of Archimedes' principle, the positive buoyancy of the hose created by the displacement of water is greater than the weight of the hose. Hence like a balloon in air or a battleship in water, the hose floats. Yet these hoses have advantages. For example, they can be easily viewed and visually inspected to ensure there are no kinks, major ruptures, or other problems. However, they may also block passage of other marine vessels from traveling between the two bodies that the hose connects together. If another marine vessel attempts to go through that space, it will almost definitely cut, tear, or otherwise rupture the hose, which depending on if and with what the hose is filled may be financially and environmentally catastrophic. As such, floating hoses are fantastic hoses for temporary uses, but are inferior for use as a permanent fluid transfer means.

Submarine hoses are designed to sink. Scientifically, this means the weight must exceed the buoyancy. Often this is accomplished by using a hose that would float under most circumstances but using concrete mats or other anchoring means to add significantly more weight than buoyancy with the overall goal to sink the hose.

Rubber hoses may sink when the hose is empty because the hose will somewhat collapse on itself, minimizing its own volume (and thus minimizing is buoyancy) past a critical point such that the weight of the fittings and the weight of the elastomeric material itself are heavy enough to overcome the minimized buoyancy.
If the hose is in use, and the specific gravity of the fluid inside the hose is equal to or greater than the specific gravity of the fluid outside the hose, and assuming the hose sinks when empty, it will necessary sink because the weight will increase faster (or at the same rate if the internal fluid is the same or has the same density as the external fluid) than the buoyancy as the hose.
However, if the specific gravity of the fluid inside the hose is less than the specific gravity of the fluid outside the hose, the buoyancy will increase faster than the weight of the hose as it expands, and there may be a critical threshold where the buoyancy overcomes the weight and the hose begins to rise. For example, this becomes very possible during an air purge or a cleaning purge with an organic solvent (that weighs less than water and even more so than sea water).
   Therefore, even with rubber submarine hoses, concrete mats or anchoring means may still be necessary under certain circumstances.

Alternatively, piping is available for use as an alternative to rubber hoses for submarine fluid transfer. There are several disadvantages to piping:
When not full of fluid media, piping will nevertheless resist collapsing. Therefore the buoyancy will not minimize, and as such the hose has a very high buoyancy compared to the weight when empty (or being air purged or the like), and much like a steel ship, it “wants” to float. Therefore, it must be permanently attached to the seafloor to resist putting stress on the terminal points.
Due to the rigid nature of piping, changes in the seafloor (earthquake, volcanic activity, drifting seafloor, or marine life interference) may put undue stresses on the piping, ultimately causing failure.
The piping must be installed in situ. It is impractical to weld long runs of pipe together before installation.
Navigating around anomalies in the sea floor are far more complicated than with hoses because pipe elbows must be used and precise lengths (meaning the pipes must be custom cut) or else the elbow may add a significant detour to go around a minor anomaly.

However, to a pipe's benefit, because water pressure does not collapse the conduit as would happen with a rubber hose, there is much less resistance on the line and it is easier to push fluid through the conduit.

Therefore, there is a need for a technique that allows a permanent fluid transfer connection, that sinks without concrete mats or anchoring means, that has a lower resistance to flow than a rubber hose, that can be easily installed in situ without having add elbows on site to navigate around anomalies, and that can withstand higher internal pressures than a rubber hose.

### SUMMARY OF THE INVENTION

The present inventors have designed a metal hose that will necessary sink even when it is full with air, that allows a permanent connection means, that has a lower resistance to flow than a rubber has, that can be easily installed in situ without having to add elbows to navigate around inconsistencies in the sea floor, and that can withstand higher internal pressure than a rubber hose generally can.

In the first aspect of the invention, the invention provides a self-sinking submarine hose assembly comprising: a flexible hose; and at least one weight mechanically attached to the hose; wherein the walls of the flexible hose are rigid such that, when the internal volume of the flexible hose is sealed and the internal volume is at atmospheric pressure, the displacement of the flexible hose is substantially the same when in air and when in seawater. The flexible hose can comprise: a flexible hose core; and at least one braid of fibers; wherein the at least one braid of fibers reinforces the flexible hose core in a manner that the pressure rating and/or burst pressure rating of the flexible hose is higher than the pressure rating of the flexible hose core when taken alone. The flexible hose core can be a corrugated metallic hose core. The corrugated metallic hose core can have radially symmetric or spiraled corrugations. The at least one braid of fibers may comprise at least two braid of metallic strands that were woven onto the flexible hose core by a machine. The at least one weight attached to the hose may comprise a plurality of buoyancy counterweights. The buoyancy counterweights may be radially symmetric and radially surround the flexible hose. The buoyancy counterweights may be distributed down the hose at substantially regular intervals. The buoyancy counterweights may have no more than 10, 5, or 2 feet of spacing between adjacent buoyancy counterweights. The buoyancy counterweights may be welded to the flexible hose. The flexible hose may additionally comprising extensions, wherein an inner face of the buoyancy counterweights are welded to a first end of the extensions and the outer face of the flexible hose is welded to the second end of the extensions, thereby mechanically securing the buoyancy counterweights to the extensions. The hose assembly may additionally comprise cleats on at least one side of the hose assembly such that when the hose is laid on the seafloor, the hose physically digs into the seafloor and gives mechanical strength to the hose to prevent the tide and current from moving the hose.

In a second aspect of the invention, a method of manufacturing a self-sinking hose is contemplated. The method comprises: providing a flexible hose which comprises: a flexible hose core; and optionally at least one layer of braided material around the flexible hose to give a higher pressure rating or burst pressure rating to the hose assembly; providing a plurality of buoyancy counterweights; and mechanically attaching the plurality of buoyancy counterweights to the flexible hose in a substantially-evenly distributed manner. The buoyancy counterweights may be radially symmetric with an annular cross-section and may be permanently or semi-permanently installed around the flexible hose. The buoyancy counterweights may be welded onto the flexible hose. The buoyancy counterweights may be spurious flanges or pipe segments.

In a third aspect of the invention, a method of using a self-sinking submarine hose is provided, comprising: providing a self-sinking hose, which comprises: a flexible hose; at least one weight mechanically attached to the hose; and terminal fittings at each end of the flexible hose; wherein the walls of the flexible hose are rigid such that, when the internal volume of the flexible hose is sealed and the internal volume is at atmospheric pressure, the displacement of the flexible hose is substantially the same when in air and when in seawater; and wherein the at least one weight and terminal fittings when considered jointly are evenly substantially evenly distributed; connecting the terminal fittings to other hoses, blind flanges, caps, or otherwise isolating the internal volume of the hose; and putting the self-sinking hose into a liquid; and sinking the hose to the substantially the bottom of the liquid. The self-sinking hose may not sink if all other variables were held the same but the at least one weight were not provided on the hose; and the self-sinking may not have portions of hose that float higher than three feet out of alignment from where the hose would naturally lie without any buoyancy effects when the internal volume of the hose is at vacuum.

### BRIEF DESCRIPTION OF THE DRAWINGS

FIG. 1 (prior art) is a schematic view of a conventional rubber submarine hose in use with an internal fluid of a lower density than the external fluid.

FIG. 2 is a side view of a submarine hose according to a first embodiment of the present invention.

FIG. 3 is a cutaway view of the layered structure of a submarine hose according to a first embodiment of the present invention.

FIG. 4 is a schematic view demonstrating buoyancy counterweights' effect on the bend radius of a submarine hose.

FIG. 5 contains three views of the pipe buoyancy counterweights according to a first embodiment of the present invention: 5(A) is a perspective view; 5(B) is a front view; and 5(C) is a side view.

FIG. 6 is a side view of a submarine hose according to a second embodiment of the present invention.

FIG. 7 contains three views of the flange buoyancy counterweights according to a second embodiment of the present invention: 5(A) is a perspective view; 5(B) is a front view; and 5(C) is a side view.

FIG. 8 contains a close-up perspective view of the flange buoyancy counterweights according to a second aspect of the present invention, connected to the continuous hose by extensions.

### DETAILED DESCRIPTION OF THE INVENTION

Without wishing to be bound by any particular theory or explanation, the current inventors will discuss their invention in detail. The following embodiments are intended to exemplify the invention only by explaining how the invention works and functions, but these embodiments are not intended to limit the scope of the invention. Instead only the claims are intended to describe the meets and bounds of the invention and the scope of this invention should be interpreted as such.

The present invention is drawn toward a hose assembly that is designed and engineered to sink without needing to be anchored down by concrete mats, anchors, externally tethered down, or the like.

Hose Assembly

In general, the hose assembly will consist of a length of metal, flexible hose segment, comprising a corrugated or other flexible inner hose, braids and/or sheaths surrounding the flexible inner hose, buoyancy counterweights, and end fittings. Other options components may be present as discussed below.

The flexible inner hose could be formed by any art recognized method, including by hydroforming, by mechanical bending, by compression, and by molding. In the case of a corrugated flexible inner hose, corrugations need not be symmetric. Any shape that allows bending without tearing the inner hose will suffice, such as helical or spiraling corrugations. Preferably the corrugations are either spiral or radially symmetric. Most preferably the corrugations are radially symmetric.

Any number of braids or sheaths can be present. There can be none, 1, 2, 3, 4, 5, 6, 7, 8, 9, 10, or more braids, with all, some, or none, of them woven onto the hose by a machine to create tighter braids and increase the pressure rating. For example, 10 braids all woven onto the hose could significantly increase the pressure rating for the hose. While no braids are within the scope of the present invention, it is noted that at least one braid is highly desirable in the case of corrugated flexible inner hose in order to increase the pressure rating and burst pressure to useful levels. Additionally, any number of sheaths can be used on the hose, including none, 1, 2, 3, 4, 5, 6, 7, 8, 9, 10, or more. The sheaths have the benefit of giving a welding point on the hose without welding the braids or risking rupturing the inner hose 225.

The length of hose can vary and it not of critical importance. The length of the hose can be as low as 6″ and as long as hundreds of feet, such as 6″, 1′, 2′, 3′, 4′, 5′, 6′, 7′, 8′, 9′, 10′, 11′, 12′, 13′, 14′, 15′, 16′, 17′, 18′, 19′, 20′, 25′, 30′, 32′, 33′, 35′, 40′, 45′, 50′, 55′, 60′, 65′, 66′, 70′, 75′, 80′, 85′, 90′, 95′, 100′, 110′, 120′, 130′, 140′, 150′, 160′, 170′, 180′, 190′, or 200′. Generally, shorter hose lengths will need less buoyancy counterweight due to metallic fittings generally making the hose heavier per average unit length. Longer hoses are generally preferred because the coupling of two fittings tends to be a failure point, and longer hose runs have fewer fittings for the same length (and thus fewer failure points).

All hose components can be made from steel grades 201, 301, 301 full hard, 304, 304L, 304 DDQ, 305, 310, 310S, 316, 316L, 321, 347, 409, 409 UF, 409 AL, 410, 430, 439, and 441. Additionally acceptable materials include, carbon steel, manganese steel, nickel steel, stainless steel, nick-chromium steel, molybdenum steel, chromium-molybdenum (i.e., chromoly) steel, nickel-chromium-molybdenum steel, nickel-molybdenum steel, chromium steel, chromium-vanadium steel, tungsten-chromium steel, silicon-manganese steel, high strength low-alloy steel, iron, cast iron, copper, bronze, tin, chrome, zinc, cobalt, aluminum, lead, silver, gold, platinum, noble metals, tungsten, molybdenum, palladium, zirconium, manganese, nickel, noble alloys, type 102 stainless steel, general steel, series 200 stainless steel, series 300 stainless steel, series 400 stainless steel, series 500 stainless steel, series 600 stainless steel, metal, alloy, heavy metal, transition metals, and combinations and alloys thereof (including alloys of alloys). Non-metallic components can also be used as buoyancy counterweights, such as glass, silicon dioxide, quartz, rocks, ceramic, sand, minerals, dirt, soil, and high density composites.

Material choice has several important qualities, but the material should be chemically resilient to whatever fluid media is in contact with it. A Teflon liner or the like can give some chemical protection to the hose itself. Further, the material properties such as the modulus, elongation, pressure resistance, and ductability needs to be considered when selecting a material.

The terminal flanges can be replaced with any art recognized end fittings with any dimensions, such as flex connectors, multiple path adapters, threaded or screw fittings, flanges, gooseneck couplings, quick connects, or barbed fittings. Particular flanges include plate flanges, weld-neck flanges, slip-on flanges, socket weld flanges, lap-joint flanges, loose flanges, threaded flanges, blind flanges, and the like Whatever end fittings or flanges are used, any dimensions can be used for such fittings. Choice of fittings is not critical so long as it is able to maintain a fluid tight seal and the material the fitting is made from is chemically resistant to both the inner and outer fluid media.

The outer diameter of the flange can be any reasonable outer diameter for flanges, measured either relative to the outer diameter of the hose or measure absolutely. In this example, the outer diameter is 21″, but it can be exactly or about 1.5″, 2″, 2.5″, 3″, 3.5″, 4″, 4.5″, 5″, 6″, 7″, 8″, 9″, 10″, 11″, 12″, 13″, 14″, 15″, 16″, 17″, 18″, 19″, 20″, 21″, 22″, 23″, 24″, 25″, 26″, 27″, 28″, 29″, 30″, 32″, 34″, 36″, 38″, 40″, 42″, 44″, 46″, 48″, 50″, 52″, 54″, 56″, 58″, 60″, 64″, 66″, 70″, 72″, 78″, 80″, 84″, 90″, 96″, or 100″. Preferably the flange is 6″-24″ in outer diameter. More preferably, the flange is 12″-22″ in outer diameter. Most preferably the flange is 21″ in outer diameter. Alternatively, the outer diameter or radius can be 0.25″ larger, 0.5″ larger, 0.75″ larger, 1″ larger, 1.25″ larger, 1.5″ larger, 1.75″ larger, 2″ larger, 2.25″ larger, 2.5″ larger, 2.75″ larger, 3″ larger, 3.5″ larger, 4″ larger, 4.5″ larger, 5″ larger, or 6″ larger than the outer radius or diameter of the continuous hose. In this alternative, 1″-4″ larger than the outer diameter of the continuous hose is preferred, with 2″ larger being most preferred.

While any hose will necessarily respond to external pressure and somewhat shrink, rigid metal hoses (such as corrugated hoses) will compress without completely collapsing. The present invention is directed toward hoses that at least partially do not collapse when submerged and empty (or alternately the internal contents are under vacuum). Therefore, the by the terminology “substantially rigid hose,” the present inventors mean a hose that while flexible can maintain external pressures internally under vacuum and still somewhat maintain their shapes. For example, elastomeric or rubber hoses will collapse when internally put under vacuum. Further, an empty rubber hose (filled with atmospheric pressures of air) will collapse when submerged in water due to the pressure of the water. However, while corrugated hoses would be expected to collapse slightly in response to physical properties that any real material has (i.e., elastic modulus), it will for the most part maintain its shape and displacement until the pressures are extreme enough for total hose failure. However, a reinforced plastic or rubber hose may be able to somewhat hold its shape and displacement when under external pressures, and therefore such hoses would qualify as a substantially rigid hose. The present hoses should be able to withstand external pressure gradients of 1 atm, 2 atm, 3 atm, 4 atm, 5 atm, 10 atm, 15 atm, 20 atm, 30 atm, 40 atm, 50 atm, 60 atm, 70 atm, 80 atm, 90 atm, or 100 atm depending on utility and service. When the present hoses are under a 1 atm uniform external pressure gradient, the hose is pulled taught, and both ends of the hose are anchored, the present hoses should be able to maintain at least 70%, 75%, 80%, 85%, 90%, 92%, 94%, 95%, 96%, 975, 98%, or 99% of its displacement.

Further, the hose assembly has a weight greater than the buoyancy of water it creates when submerged at 10 feet, 20 feet, 30 feet, 40 feet, 50 feet, 60 feet, 70 feet, 80 feet, 90 feet, 100 feet, 150 feet, 200 feet, 250 feet, 300 feet, 350 feet, 400 feet, 450 feet, or 500 feet.

Archimedes' Principle, Buoyancy, and Weight

As discussed above, Archimedes' principle explains that the positive buoyancy (the force that makes helium balloons rise in the air and steel ships float) is equal to the weight of the external fluid displaced. Mathematically and physically, it can be expressed as:

β=gρV (1)

where β is the buoyant force, g is the acceleration due to gravity (9.8 m/s² on Earth), p is the density of the media being displaced (1.000 g/cm³ for water and 1.025 g/cm³ for sea water), and V is the volume of media being displaced. Buoyancy is an important when determining if a hose will sink or float as it creates a second force to counteract weight, which explains why balloons rise and ships float. If the positive buoyancy is greater than the weight the object will float, which is a state known as “positive buoyancy”. If the weight is greater than the positive buoyancy, the object will sink, which is a state known as “negative buoyancy”. It is possible that the buoyancy and the weight are roughly the same, causing a state of “neutral buoyancy” where an object will neither sink nor float. For example, consider scuba divers that want a state of neutral buoyancy so they can go up or down at will.

But back to considering the critically importance of this concept to hoses, adding any mass to the exterior of a hose will necessarily take more volume and increase the volume of the media being displaced, thereby raising the buoyancy. As such, a material that weight 100 pounds may only weigh 80 pounds in sea water, so it is critical to take that into account when determining how much weight must be added to a hose to cause it to properly sink.

Weight of Stainless Steel 316 in Seawater

The weight and buoyancy of stainless steel 316 is calculated per unit volume from known information. The density of stainless steel 316 is as supplied by AK Steel Corporation has the following composition:

TABLE 1
The composition of AK Steel Corporation's stainless steel 316(L),
considered exemplary stainless steel 316 compositions.

| | TYPE 316 | | TYPE 316L | |
|---|---|---|---|---|
| Carbon | 0.08 | wt. % max. | 0.03 | wt. % max. |
| Manganese | 2.00 | wt. % max. | 2.00 | wt. % max. |
| Phosphorous | 0.045 | wt. % max. | 0.045 | wt. % max. |
| Sulfur | 0.030 | wt. % max. | 0.030 | wt. % max. |
| Silicon | 0.75 | wt. % max. | 0.75 | wt. % max. |
| Chromium | 16.00-18.00 | wt. % | 16.00-18.00 | wt. % |
| Nickel | 10.00-14.00 | wt. % | 10.00-14.00 | wt. % |
| Molybdenum | 2.00-3.00 | wt. % | 2.00-3.00 | wt. % |
| Nitrogen | 0.10 | wt. % max. | 0.10 | wt. % max. |

| | | |
|---|---|---|
| Iron | Balance | Balance |

The density of this composition is 7.99 g/cm³. Therefore, by subtracting the density of sea water (the amount of water displaced; 1.025 g/cm³), it is shown that amount of weight added to a body in sea water—taking buoyancy into account when stainless steel 316 is used as a buoyancy counterweight and is added externally to the body—is 6.96 g/cm³. From this information it becomes simpler to target a specific weight using the following ratio:

$$\frac{{W}_{SS 316 OUT OF SEAWATER}}{{W}_{SS 316 IN SEA WATER}} = \frac{7.99 g \text{/} {cm}^{3}}{6.96 g \text{/} {cm}^{3}} \qquad ( 2 )$$

wherein W_{SS316 OUT OF SEAWATER} is the weight of stainless steel 316 as generally measured in the open atmosphere, and W_{SS316 IN SEAWATER} is the weight of the stainless steel 316 in sea water. This ratio can be solved to:

W_{SS316 OUT OF SEAWATER}=1.158·W_{SS316 IN SEA WATER} (3)

For example, if it was desirable to add 1000 pounds to a body in seawater to properly sink the body, the skilled artisan would calculate that we would actually need to add 1,158 lbs. of stainless steel 316.

While this calculation is prepared for stainless steel 316 in seawater, other materials in other external media can be performed using the same mathematical steps. Our preference for stainless steel 316 in the present disclosure is not intended to be limiting to stainless steel buoyancy counterweights.

Buoyancy Counterweights

The buoyancy counterweights can be any construction that adds weight to the hose down the axial length of the hose (even when in a dense external media and buoyancy is taken into account) in a manner that distributes that weight down the hose in the external media to prevent the hose from rising to the surface.

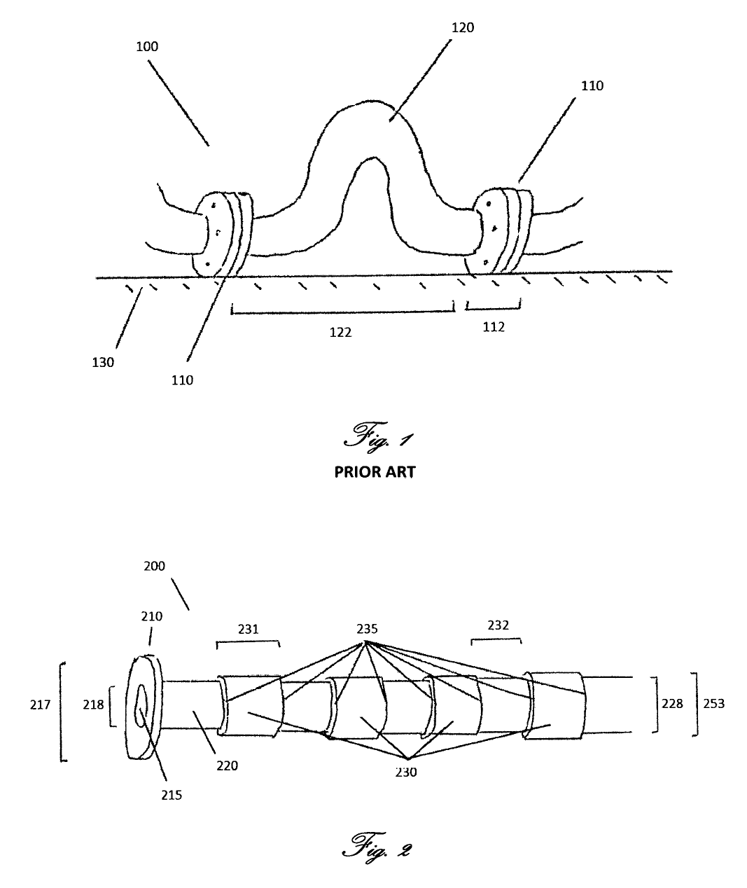

While extremely heavy terminal couplings or fittings may be heavy enough to increase the weight of the entire hose apparatus to keep the hose weighed down to the seafloor, the hose may snake (see discussion related to comparative example 1 and FIG. 1 below) if sufficiently flexible and lengthy. Given that longer hose runs are desirable to minimize hose failure points, and snaking is undesirable, a critical aspect of the present invention is that buoyancy counterweights are distributed down the length of the hose. The spacing can be random, regular, or semi-regular. Preferably the spacing is substantially regular. In the event of a single buoyancy counterweight, the counterweight is preferably in the middle of the flexible hose, but may be anywhere along the hose length for certain engineering and application protocols.

The length, thickness, and material choice for buoyancy counterweights (possibly switching to a material more dense than stainless steel) can be controlled to ensure that enough buoyancy counterweight is present to actually sink the hose. Further, the spacing between two counterweights is a variable to control how many counterweights are on a given length of the hose and to ensure that the bend radius is not overly constricted. By distributing the buoyancy counterweights down the length of the hose, the hose does not have enough buoyancy at any point to bend beyond a small amount, preventing the snaking phenomenon of example 1 (see comparative example below).

Preferably the buoyancy counterweights radially surround the hose. Examples are flanges, including plate flanges, weld-neck flanges, slip-on flanges, socket weld flanges, lap-joint flanges, loose flanges, threaded flanges, machined blind flanges, or the like; pipes segments; metallic rings, hoops, and other metallic constructions with an annular cross section; and the like.

When the buoyancy counterweight radially surrounds the hose, the inner diameter of the buoyancy counterweight can either be flush with the outer diameter of the hose (or sheath or braids) such that it can be directly welded, or it can be slightly larger such that it can still effectively be directly welded, or it can be significantly larger, such that extensions are welded to the inner surface of the counterweights and in turn welded to the outer surface of the hose (or sheath or braids). The gap size between the hose and the flange counterweights (if a gap is present) can be any reasonable size, such as about 0.1″, 0.2″, 0.3″, 0.4″, 0.5″, 0.6″, 0.7″, 0.8″, 0.9″, 1″, 1.25″, 1.5″, 1.75″, 2″, 2.5″, 3″, or larger if desired. Preferably the gap is about 0.2″-1″, most preferably being about 0.5″.

Any material denser than the outer media can be used for the counterweight. For example, steel grades 201, 301, 301 full hard, 304, 304L, 304 DDQ, 305, 310, 310S, 316, 316L, 321, 347, 409, 409 UF, 409 AL, 410, 430, 439, and 441 can all be used. Additional materials include, carbon steel, manganese steel, nickel steel, stainless steel, nick-chromium steel, molybdenum steel, chromium-molybdenum (i.e., chromoly) steel, nickel-chromium-molybdenum steel, nickel-molybdenum steel, chromium steel, chromium-vanadium steel, tungsten-chromium steel, silicon-manganese steel, high strength low-alloy steel, iron, cast iron, copper, bronze, tin, chrome, zinc, cobalt, aluminum, lead, silver, gold, platinum, noble metals, tungsten, molybdenum, palladium, zirconium, manganese, nickel, noble alloys, type 102 stainless steel, general steel, series 200 stainless steel, series 300 stainless steel, series 400 stainless steel, series 500 stainless steel, series 600 stainless steel, metal, alloy, heavy metal, transition metals, and combinations and alloys thereof (including alloys of alloys). Non-metallic components can also be used as buoyancy counterweights, such as glass, silicon dioxide, quartz, rocks, ceramic, sand, minerals, dirt, soil, and high density composites.

In the case of flange counterweights, the outer diameter of the flange can be any reasonable outer diameter for flanges, measured either relative to the outer diameter of the hose or measure absolutely. Generally the outer diameter of the flange can be exactly or about 1.5″, 2″, 2.5″, 3″, 3.5″, 4″, 4.5″, 5″, 6″, 7″, 8″, 9″, 10″, 11″, 12″, 13″, 14″, 15″, 16″, 17″, 18″, 19″, 20″, 21″, 22″, 23″, 24″, 25″, 26″, 27″, 28″, 29″, 30″, 32″, 34″, 36″, 38″, 4.0″, 42″, 44″, 46″, 48″, 50″, 52″, 54″, 56″, 58″, 60″, 64″, 66″, 70″, 72″, 78″, 80″, 84″, 90″, 96″, or 100″. Preferably the flange is 6″-24″ in outer diameter. More preferably, the flange is 12″-22″ in outer diameter. Most preferably the flange is 21″ in outer diameter. Alternatively, the outer diameter or radius can be 0.25″ larger, 0.5″ larger, 0.75″ larger, 1″ larger, 1.25″ larger, 1.5″ larger, 1.75″ larger, 2″ larger, 2.25″ larger, 2.5″ larger, 2.75″ larger, 3″ larger, 3.5″ larger, 4″ larger, 4.5″ larger, 5″ larger, or 6″ larger than the outer radius or diameter of the continuous hose. In this alternative, 1″-4″ larger than the outer diameter of the continuous hose is preferred, with 2″ larger being most preferred.

In the case of pipe segment counterweights, the pipe segments can be of any dimension that would benefit the hose and have enough weight in the external media to counteract the buoyancy of the hose. Ideally, the pipe will have an inner diameter roughly equal to or slightly larger than the outer diameter of the hose, such as about 0.25″, 0.5″, 0.75″, 1″, 1.25″, 1.5″, 1.75, or 2″ larger. The pipe segments can be of any length and spaced apart at any length apart, but are preferably shorter and spaced apart down the hose about 12″ from the beginning of one pipe segment to the beginning of the next pipe segment. The pipe segment lengths can be 0.25″, 0.5″, 0.75″, 1″, 1.5″, 2″, 2.5″, 3″, 3.5″, 4″, 4.5″, 5″, 6″, 7″, 8″ 9″, 10″, 11″, or 12″ long. They can be spaced apart and welded to the hose with 0.5″, 1″, 1.5″ 2″, 3″, 4″, 5″, 6″, 7″, 8″, 9″, 10″, 11″, 12″, 14″, 16″, 18″ 20″, 22″, 24″, 30″, 36″, 42″, 48″, 56″, or 60″ apart. The outer diameter can be any practical outer diameter, such as about 1.5″, 2″, 2.5″ 3″, 3.5″, 4″, 6″, 6″, 7″, 8″, 9″, 10″, 11″, 12″, 13″, 14″, 15″, 16″, 17″, 18″, 19″, 20″, 21″, 22″, 23″, 24″, or larger if necessary.

The buoyancy counterweights must weigh more than the volume of external media they displace weights, or else the buoyancy will be higher than the weight added and they will “float” instead of sink. In practice, the weight should be substantially higher than the buoyancy so that smaller amount of material can be added, and the weight efficiency of the final hose assembly house of water can be minimized for cheaper transportation. Generally, the weight of the buoyancy counterweight out of external media divided by the weight of the buoyancy counterweight in external media should be less than or equal to 2.0 to be effective. Preferably, this number is less than 1.5. Even more preferably this number is less than 1.2. Yet even more preferably this number is less than 1.1. In a most preferred embodiment, this number is less than 1.05.

Cleats

The hose or the buoyancy counterweights can be retrofitted to include cleats. The cleats can be strapped on, welded on, integrated with or otherwise attached to or part of the present invention. The cleats will be on one or more sides of the hose or counterweights and function to “dig” the hose into the sea floor to help resist movement from currents or tides.

### Example 1 (Comparative)—Undulating Rubber Hose

There are currently submarine hoses available that may sink when empty or when full of fluid. As noted above, this is because the external fluid displacement is minimized when the hose is empty due to the weight of the external fluid (i.e., the hose collapses). However, the density of the rubber itself is lower than the density of water or seawater, so the hose portions would actually float. However, the overall hose itself does not float because the flanges to connect multiple hoses together add substantial weight, anchoring the hose to the sea floor. Considering the following scenario:

TABLE 2
Demonstrating that while the hose itself will sink,
portions of that hose may still try to rise.

| | | | | SINK/ |
|---|---|---|---|---|
| | BUOYANCY | WEIGHT | BALANCE | FLOAT |
| Flange | 20 lbs. | 300 lbs. | 280 lbs. | Sink |
| Hose Length | 1,200 lbs. | 1,100 lbs. | −100 lbs. | Float |
| Overall | 1,220 lbs. | 1,400 lbs. | 180 lbs. | Sink |

For example, see FIG. 1 (prior art). Conventional submarine rubber hose 100 is on the seafloor 130. Flanges 110 are heavier than the buoyancy they create or bound in sea water, and therefore flanges 110 sink, creating a sinking region 112. Rubber hose 120 is currently filled with a lower 0.90 specific gravity crude oil. Because sea water has a specific gravity of around 1.025, the buoyancy is greater of the hose portions are greater than the weight, making them try to float in floating region 122. Further, rubber hose 120 itself also has a specific gravity of lower than the seawater. The net result is an undulating fluid transport means. The flanges 110 are overall heavy enough to keep the hose submerged, but the rubber hose 120's raised portions drift in the sea water, which can also catch currents such as rip currents and drag the hose. Further, for long hoses, such raised portions can approach the surface and risk being cut by passing marine vessels. Counteracting floating regions 120 requires additional anchoring means or concrete mats that must be added in situ. As such, this hose is undesirable.

### Example 2 (Comparative)—Floating Rubber Hose

Considering the hose of example 1, if the 0.90 specific gravity crude oil were replaced with a less dense specific gravity organic oil without changing the volume of the hose (and therefore without changing the hose's buoyancy), then the skilled artisan may expect the hose itself to float. Consider the following scenario:

TABLE 3
Demonstrating that while the hose itself will sink,
portions of that hose may still try to rise.

| | | | | SINK/ |
|---|---|---|---|---|
| | BUOYANCY | WEIGHT | BALANCE | FLOAT |
| Flange | 20 lbs. | 300 lbs. | 280 lbs. | Sink |
| Hose Length | 1,200 lbs. | 850 lbs. | −350 lbs. | Float |
| Overall | 1,220 lbs. | 1,150 lbs. | 70 lbs. | Float |

### Example 3—Stainless Steel 316 Stainless Steel Pipe as Buoyancy Counterweights

Stainless steel pipe can be used as a buoyancy counterweight by welding such stainless steel pipe onto a continuous length of hose going through the pipe. The advantages of stainless steel pipe is that is can be purchased relatively form fit to the hose. The disadvantage of stainless steel pipe is that because it is not as thick as other items, lots of pipe can significantly hinder the bend radius of the hose, making the hose less like a hose and more like a pipe.

Referring now to FIG. 2, a first embodiment 200 of the present invention is shown. 50 foot of continuous hose 220 is bounded by a flange 210 with outer diameter 217 (21″) and opening 215 and internal diameter of 212 (12″) on a first end, and a second flange (not shown) on the other end. Buoyancy counterweights (stainless steel 316 pipe segments) 230 have an inner diameter (14.314″) that hugs continuous hose 220 and a thickness that extends radially toward the outer diameter 233 (16″). Each buoyancy counterweight 230 has a predetermined length 231 (4″) and has spacing 232 between its adjacent counterweights (12″ from pipe start to the next pipe start, for a total of 8″ between counterweights). Each buoyancy counterweight 230 has a weld 235 at each terminal axial end of the counterweight, thereby securing it in place.

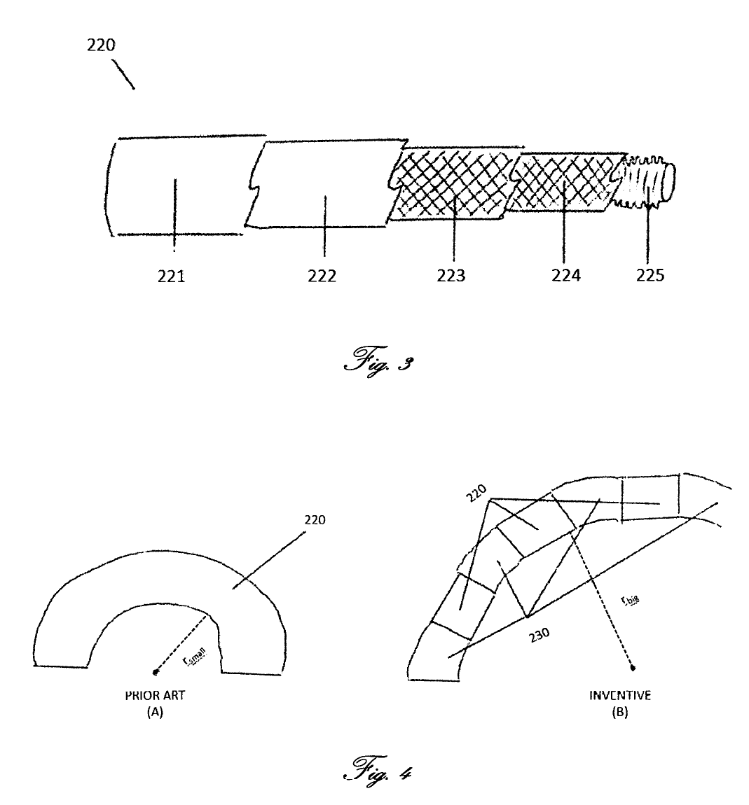

Referring now to FIG. 3, the layers of continuous hose 220 are shown. Outer protective sheath 221 has an internal diameter of 15″. Internal protective sheath 222 has an internal diameter of 14″. These sheaths allow fluid to slowly penetrate them, so they will flood with external media and will not create undue buoyancy. Braids 223 and 224 give strength and integrity to inner hose 225. The braids 223 and 224 were woven tightly onto the inner hose 225 such that they raise the pressure rating of the hose from about 5 psi to about 325 psi with a burst pressure of around 1800 psi. Sheaths 221 and 222 are added to give extra weight and protection to the hose. Inner hose 225 is a 12″ inner diameter, radially-symmetric corrugated hose. The outer diameter is roughly 13″. The corrugations were hydroformed.

Referring to FIG. 4, two hoses are shown. The first hose—“(A)”—is a comparative hose without the inventive buoyancy counterweights (i.e., our starting apparatus). The second hose—“(B)”—is a finished run of hose without flanges, according to a first embodiment of the invention. Of note, the bend radius of the same hose goes from r_{SMALL} to r_{BIG} because of sections of the hoes that will not bend because they are welded to the interior of a pipe segment. The general formula for calculating the bend radius is:

$${r}_{NEW BEND} = {r}_{OLD BEND} \frac{{L}_{HOSE LENGTH}}{{L}_{HOSE LENGTH} - {n}_{PIPE SEGMENTS} \cdot {L}_{PIPE SEGMENT}} \qquad ( 4 )$$

where r_{NEW BEND} is the inventive bend radius, r_{OLD BEND} is the bend radius of the unaltered (prior art) hose, L_{HOSE LENGTH} is the length of the entire hose assembly, n_{PIPE SEGMENTS} is the number of pipe segment buoyancy counterweights, and L_{PIPE SEGMENT} is the length of each pipe segment's inner diameter. In a preferred embodiment, the sides of the pipe segment walls are tapered such that the inner pipe segment length is smaller than the outer diameter pipe segment length, which adds more weight with less detriment to the bend radius.

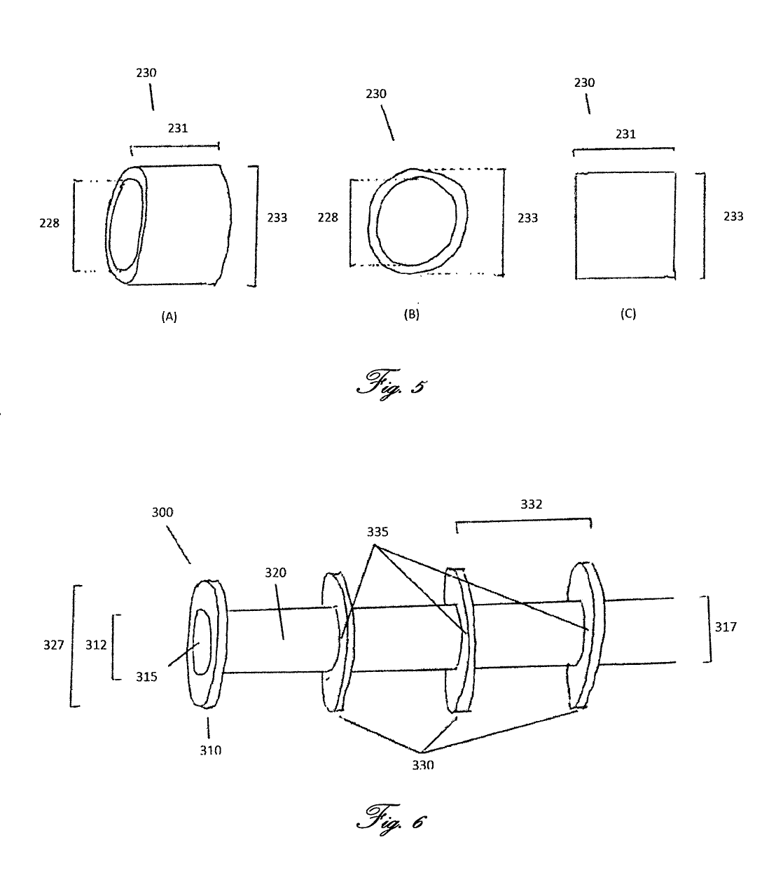

Referring now to FIG. 5, several views of the inventive pipe segment buoyancy counterweights are shown according to a first embodiment of the invention. FIG. 5(A) is a perspective view; FIG. 5(B) is a front view; and FIG. 5(C) is a side view. 4 inch long (reference mark 231) pipe segment buoyancy counterweights 230 are used. There is 8″ of space between adjacent counterweights (i.e., from the beginning of one counterweight to the beginning of the next is 12″), for a total of 49 segments in total for the 50′ hose length. Therefore because the hose has a dynamic bend radius of 27″ and a static bend radius of 60″ before the pipe segments were added, the final bend radius will be: 40″ and 89″, respectively. The outer diameter (reference mark 233) of the pipe segments are 16″ and the inner diameter (reference mark 228) is 14.314″, as this pipe segment is 16″ nominal schedule 80 stainless steel 316 pipe. Therefore, we can estimate the weight of the pipe to be 2,230 lbs., and the buoyancy is only about 291 lbs., which effectively increases the weight of the hose in water about 1939 lbs. Without this buoyancy counterweight, the hose would float when full with air.

Consider the following table that shows the hose assembly when full of air, with and without counterweights:

TABLE 4
Demonstrating the effectiveness of the buoyancy counterweights.

| | | | | SINK/ |
|---|---|---|---|---|
| | WEIGHT | BUOYANCY | BALANCE | FLOAT |
| Hose and | 834 lbs. | 32 lbs. | 802 lbs. | Sink |
| Flanges | | | | |
| Braids | 561 lbs. | 263 lbs. | 298 lbs. | Sink |
| Sheaths | 1,268 lbs. | 167 lbs. | 1,101 lbs. | Sink |
| Trapped Air | 4 lbs. | 2,812 lbs. | −2,808 lbs. | Float |
| Counterweights | 2,230 lbs. | 291 lbs. | 1,939 lbs. | Sink |
| (“CW”) | | | | |
| Total w/o CWs | 2,667 lbs. | 3,274 lbs. | −600 lbs. | Float |
| Total w/CWs | 4,897 lbs. | 3,565 lbs. | 1,332 lbs. | Sink |

Importantly, without the weight of the counterweights, this hose would not sink when full of air. However, give the inventive design, the hose is able to sink under its own weight.

In this example, all materials are made of stainless steel 316, including welds.

### Example 4—Spurious Flanges as Buoyancy Counterweights

Another hose was prepared as in example 3, except instead of using pipe segments as buoyancy counterweights, spurious flanges were used as buoyancy counterweights.

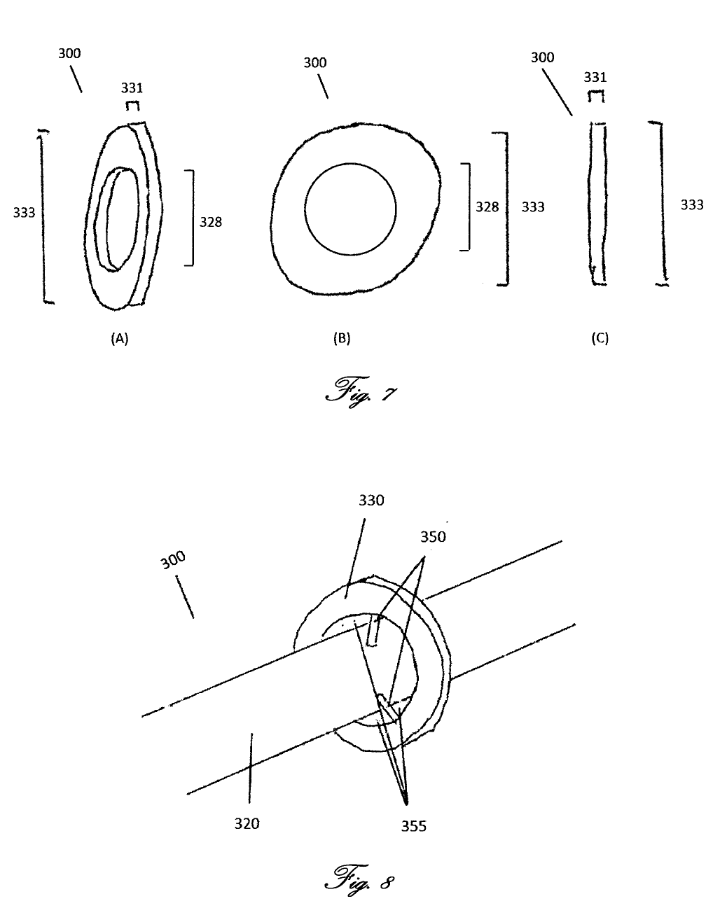

Referring now to FIG. 6, a second embodiment 300 of the present invention is shown. 50 foot of continuous hose 320 is bounded by a terminal flange 310 with outer diameter 317 (21″) and opening 315 and internal diameter of 312 (12″) on a first end, and a second flange (not shown) on the other end. Buoyancy counterweights (stainless steel 316 plate flanges) 330 have an inner diameter that with a small gap at 335 (not seen; See FIG. 7 for more). Each buoyancy counterweight 330 has a predetermined length 331 (1.875″) and has spacing 332 between its adjacent counterweights (24″ from pipe start to the next pipe start, for a total of 22.125″ between counterweights). Each buoyancy counterweight 330 is welded in place. The hose 320 is the same hose or can be customized as described for hose 220 in the first embodiment, as can the terminal flanges 310 (compared to flanges 210 in the first embodiment).

Referring now to FIG. 7, several views of the inventive plate flange buoyancy counterweights are shown according to a second embodiment of the invention. FIG. 5(A) is a perspective view; FIG. 5(B) is a front view; and FIG. 5(C) is a side view. 1.875 inch thick (reference mark 331) plate flange buoyancy counterweights 330 are used. There is 22.125″ of space between adjacent counterweights (i.e., from the beginning of one counterweight to the beginning of the next is 12″), for a total of 24 segments in total for the 50′ hose length. Unlike with pipe segments in the first embodiment of the invention, the bend radius change will be almost negligible because the inner diameter of the plate flanges are larger than the outer diameter of the hose. The two are mounted together using short rods, one end welded to the flange, the other welded to the outer diameter of the hose. The outer diameter of the flange (reference mark 333) of the flanges are 21″ and the inner diameter (reference mark 328) is larger than the outer diameter of the hose.

TABLE 5
Demonstrating the effectiveness of the buoyancy counterweights.

| | | | | SINK/ |
|---|---|---|---|---|
| | BUOYANCY | WEIGHT | BALANCE | FLOAT |
| Hose and Flanges | 834 lbs. | 32 lbs. | 802 lbs. | Sink |
| Braids | 561 lbs. | 263 lbs. | 298 lbs. | Sink |
| Sheaths | 1,268 lbs. | 167 lbs. | 1,101 lbs. | Sink |
| Trapped Air | 4 lbs. | 2,812 lbs. | −2,808 lbs. | Float |
| Counterweights | 2,304 lbs. | 301 lbs. | 2,303 lbs. | Sink |
| (“CW”) | | | | |
| Total w/o CWs | 2,667 lbs. | 3,274 lbs. | −607 lbs. | Float |
| Total w/CWs | 4,971 lbs. | 3,575 lbs. | 1,396 lbs. | Sink |

Referring now to FIG. 8, a close up of the extensions to connect the plate flange to the hose can be seen. A second embodiment of the invention has plate flange 330 welded to continuous hose 320 by welding extensions 350 to both the continuous hose 320 and the flange 330. Gaps 355 are between the flange and the hose, which gives the hose maximum flexibility while still adding weight. The gap width is about 0.5″ in this example.

1. A self-sinking submarine hose assembly comprising:
a flexible, substantially rigid hose; and
at least one weight mechanically mated to the hose,
wherein the weight of the hose is greater than the buoyancy the hose creates in water at a depth of 10 feet.

2. The self-sinking submarine hose assembly of claim 1, wherein the flexible hose comprises:
a flexible, substantially rigid hose core; and
at least one braid of fibers;
wherein the at least one braid of fibers reinforces the flexible hose core in a manner that the pressure rating and/or burst pressure rating of the flexible hose is higher than the pressure rating of the flexible hose core when taken alone.

3. The self-sinking submarine hose assembly of claim 2, wherein the flexible hose core is a corrugated metallic hose core.

4. The self-sinking submarine hose assembly of claim 3, wherein the corrugated metallic hose core is a radially symmetric or spiraled corrugations.

5. The self-sinking submarine hose assembly of claim 2, wherein the at least one braid of fibers comprises at least two braid of metallic strands that were woven onto the flexible hose core by a machine.

6. The self-sinking submarine hose assembly of claim 1, wherein the at least one weight attached to the hose comprises a plurality of buoyancy counterweights.

7. The self-sinking submarine hose assembly of claim 6, wherein the buoyancy counterweights are radially symmetric and radially surround the flexible hose.

8. The self-sinking submarine hose assembly of claim 7, wherein the buoyancy counterweights are distributed down the hose at substantially regular intervals.

9. The self-sinking submarine hose assembly of claim 8, wherein the buoyancy counterweights have no more than 10 feet of spacing between adjacent buoyancy counterweights.

10. The self-sinking submarine hose assembly of claim 9, wherein the buoyancy counterweights have no more than 5 feet of spacing between adjacent buoyancy counterweights.

11. The self-sinking submarine hose assembly of claim 10, wherein the buoyancy counterweights have no more than 2 feet of spacing between adjacent buoyancy counterweights.

12. The self-sinking submarine hose assembly of claim 7 wherein the buoyancy counterweights are welded to the flexible hose.

13. The self-sinking submarine hose assembly of claim 7 additionally comprising extensions, wherein an inner face of the buoyancy counterweights are welded to a first end of the extensions and the outer face of the flexible hose is welded to the second end of the extensions, thereby mechanically securing the buoyancy counterweights to the extensions.

14. The self-sinking submarine hose assembly of claim 1, additionally comprising cleats on at least one side of the hose assembly such that when the hose is laid on the seafloor, the hose physically digs into the seafloor and gives mechanical strength to the hose to prevent the tide and current from moving the hose.

15. A method of manufacturing a self-sinking hose, comprising:
providing a flexible hose which comprises:
a flexible hose core; and
optionally at least one layer of braided material around the flexible hose to give a higher pressure rating or burst pressure rating to the hose assembly;
providing a plurality of buoyancy counterweights; and
mechanically attaching the plurality of buoyancy counterweights to the flexible hose in a substantially-evenly distributed manner.

16. The method claim 15, wherein the buoyancy counterweights are radially symmetric with an annular cross-section and are permanently or semi-permanently installed around the flexible hose.

17. The method claim 15, wherein the buoyancy counterweights are welded onto the flexible hose.

18. The method of claim 15, wherein the buoyancy counterweights are spurious flanges or pipe segments.

19. A method of using a self-sinking submarine hose, comprising:
providing a self-sinking hose, which comprises:
a flexible, substantially rigid hose;
at least one weight mechanically attached to the hose; and
terminal fittings at each end of the flexible hose;
wherein the at least one weight and terminal fittings when considered jointly are evenly substantially evenly distributed;
connecting the terminal fittings to other hoses, blind flanges, caps, or otherwise isolating the internal volume of the hose; and
putting the self-sinking hose into a liquid; and
sinking the hose to the substantially the bottom of the liquid using the hose's own weight.

20. The method of claim 19, wherein the self-sinking hose would not sink if all other variables were held the same but the at least one weight were not provided on the hose; and
wherein the self-sinking does not have portions of hose that float higher than three feet out of alignment from where the hose would naturally lie without any buoyancy effects when the internal volume of the hose is at vacuum.
